(19) United States
(12) Patent Application Publication
(10) Pub. No.: US 2018/0045163 A1
(43) Pub. Date: Feb. 15, 2018

(54) CONDITIONAL ENGINE IGNITERS

(71) Applicant: Sikorsky Aircraft Corporation, Stratford, CT (US)

(72) Inventor: George Nicholas Loussides, Branford, CT (US)

(21) Appl. No.: 15/556,775

(22) PCT Filed: Mar. 11, 2016
(86) PCT No.: PCT/US2016/022034

§ 371 Date: Sep. 8, 2017

Related U.S. Application Data
(60) Provisional application No. 62/132,055, filed on Mar. 12, 2015.

(51) Int. Cl. F02P 5/15; B64D 31/06; F02D 41/22

(52) U.S. Cl. CPC F02P 5/1502; F02D 41/22; B64D 31/06; F02D 2200/70; B64C 39/024

(57) ABSTRACT

A system and method for preventing a flame out condition in at least one engine, includes detecting a moisture content exceeding a threshold moisture content in an operating environment of the at least one engine, and engaging at least one igniter associated with the at least one engine in response to the moisture content.

### FIELD OF THE INVENTION

The subject matter disclosed herein relates to engine operations in an aircraft, and to a system and a method for engaging an engine igniter in response to a high moisture environment.

### DESCRIPTION OF RELATED ART

Typically, modern aircraft, e.g. fixed wing aircraft, rotary wing aircraft, unmanned aerial vehicles, etc., require certain operating conditions and adjustments for desired engine performance and flight performance. Further, such adjustments may require pilot or operator intervention, sometimes during severe conditions.

Aircraft engines are often sensitive to flame out conditions, including high moisture conditions. Engine flame outs can cause undesired low performance and require additional operator attention or poor performance. A system and method that can detect flame out conditions and prevent flame outs from occurring is desired.

### BRIEF SUMMARY

According to an embodiment of the invention, a method for preventing a flame out condition in at least one engine, includes detecting a moisture content exceeding a threshold moisture content in an operating environment of the at least one engine, and engaging at least one igniter associated with the at least one engine in response to the moisture content.

In addition to one or more of the features described above, or as an alternative, further embodiments could include disengaging the at least one igniter associated with the at least one engine in response to the moisture content below the threshold moisture content.

In addition to one or more of the features described above, or as an alternative, further embodiments could include that the at least one engine is associated with an optionally piloted vehicle or an unmanned air vehicle.

In addition to one or more of the features described above, or as an alternative, further embodiments could include detecting the moisture content via a moisture sensor or an atmospheric condition sensor.

In addition to one or more of the features described above, or as an alternative, further embodiments could include comparing the moisture content with the threshold moisture content via a vehicle management computer.

In addition to one or more of the features described above, or as an alternative, further embodiments could include setting the threshold moisture content.

In addition to one or more of the features described above, or as an alternative, further embodiments could include that the threshold moisture content is a relative or absolute humidity percentage.

In addition to one or more of the features described above, or as an alternative, further embodiments could include indicating to an operator to engage the at least one igniter in response to the moisture content.

In addition to one or more of the features described above, or as an alternative, further embodiments could include indicating to the operator a status of the at least one igniter.

In addition to one or more of the features described above, or as an alternative, further embodiments could include that the moisture content includes an ice content.

According to an embodiment of the invention, a system for preventing a flame out condition in at least one engine, includes at least one sensor to detect a moisture content exceeding a threshold moisture content in an operating environment of the at least one engine, and a controller to engage at least one igniter associated with the at least one engine in response to the moisture content.

In addition to one or more of the features described above, or as an alternative, further embodiments could include that the controller disengages the at least one ignitor associated with the at least one engine in response to the moisture content below the threshold moisture content.

In addition to one or more of the features described above, or as an alternative, further embodiments could include that the controller is integrated with a vehicle management computer.

In addition to one or more of the features described above, or as an alternative, further embodiments could include that the controller sets the threshold moisture content.

In addition to one or more of the features described above, or as an alternative, further embodiments could include that the controller indicates to an operator a status of the at least one igniter.

Technical function of the embodiments described above includes engaging at least one igniter associated with the at least one engine in response to the moisture content.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a schematic isometric view of an aircraft in accordance with an embodiment of the invention;

FIG. 2 illustrates a schematic view of an exemplary conditional igniter system in accordance with an embodiment of the invention; and

FIG. 3 is a flow diagram of a method of conditionally engaging igniters in accordance with an embodiment of the invention.

### DETAILED DESCRIPTION OF THE INVENTION

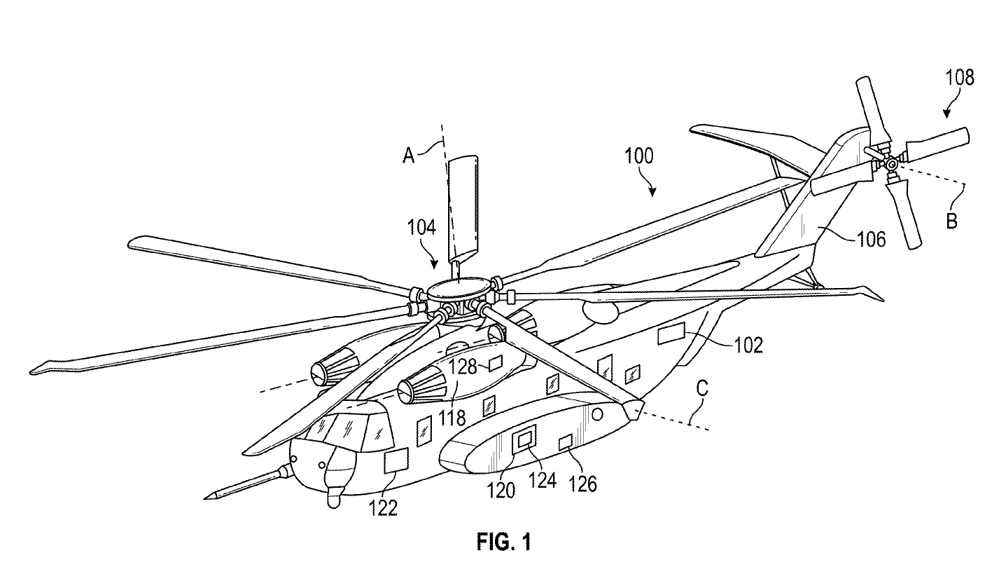

Referring now to the drawings, FIG. 1 illustrates a general perspective view of an exemplary vehicle in the form of aircraft 100 for use with a conditional igniter system in accordance with an embodiment of the invention. In an embodiment, aircraft 100 is an optionally piloted vehicle and can autonomously perform required igniter operations as it traverses a flight plan. In certain embodiments, aircraft 100 can be any suitable aircraft, including fixed wing, rotary wing aircraft, etc. Aircraft 100 includes an airframe 102, an engine 118, a plurality of sensors 122, and a vehicle management computer 120.

Airframe 102 of aircraft 100 includes a main rotor 104, an extending tail 106 which mounts an anti-torque system, such as a tail rotor 108. Main rotor 104 and tail rotor 108 are driven to rotate by one or more engines 118 through one or more gearboxes (not shown). In certain embodiments, performance and operation of engines 118 are affected by environmental conditions that can cause flame out conditions.

In an exemplary embodiment, sensors 122 are disposed on airframe 102 of aircraft 100. Sensors 122 can include moisture sensors, atmospheric sensors, etc. Sensors 122 can be of any suitable type and can be used to sense potential flame out conditions.

Vehicle management computer 120 can be utilized to control vehicle functions, including but not limited to control functions, engine management, etc. In an exemplary embodiment, signals from sensors 122 are received by vehicle management computer 120 and are utilized to manage flame out conditions.

In an exemplary embodiment, flameout conditions logic controller 124 can work with, or independently from vehicle management computer 120 to monitor sensor feedback for flame out conditions. In certain embodiments, flame out logic controller 124 is integrated with vehicle management computer 120. In certain embodiments, flameout logic controller 124 is software logic integrated with vehicle management computer 120.

In certain embodiments, flameout conditions logic controller 124 and/or vehicle management computer 120 can signal to igniter 128 or igniter control 126 to engage the igniters 128 to proactively avoid a flame out condition. In an exemplary embodiment, igniters 128 are engaged as long as flame out conditions are present. After flame out conditions are no longer present, igniters 128 may be disengaged.

Although a particular aircraft is illustrated and described in the disclosed embodiment, it will be appreciated that other configurations and/or machines including autonomous and optionally piloted aircraft that may operate in land or water including fixed-wing aircraft, rotary-wing aircraft, and land vehicles (e.g., trucks, cars, etc.) may also benefit from embodiments disclosed.

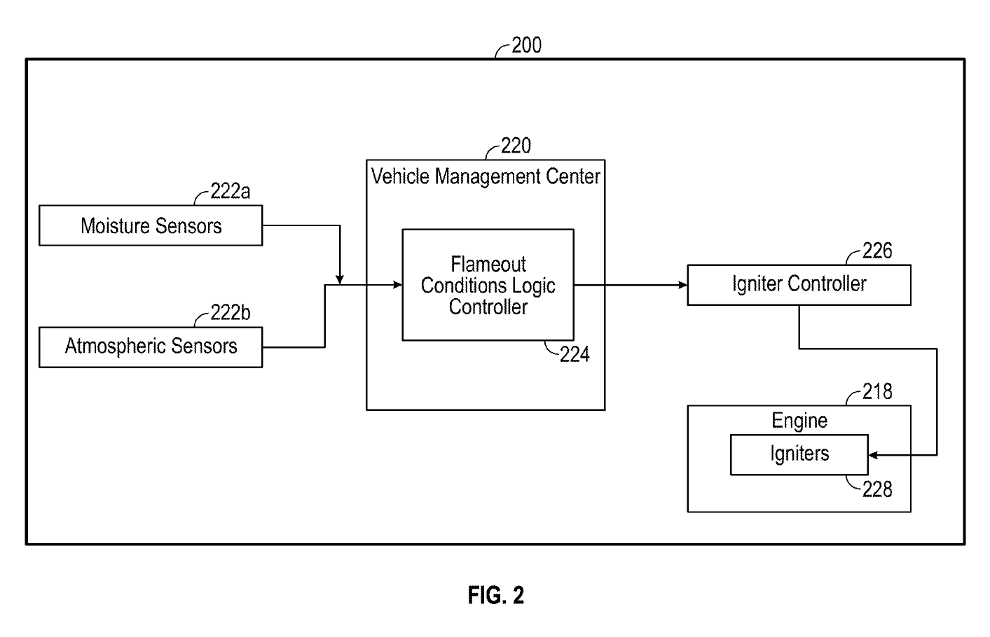

As illustrated in FIG. 2, a conditional igniter system 200 is shown. In an exemplary embodiment, conditional igniter system 200 includes sensors 222a , 222b , flameout conditions logic controller 224, and igniters 228.

In an exemplary embodiment, sensors 222a , 222b can be standalone sensors, sensors for other vehicle systems, or sensors integrated with other vehicle systems. In an exemplary embodiment, moisture sensors 222a can detect moisture within an environment, while atmospheric sensors 222b can be configured to detect broadband atmospheric conditions. In an exemplary embodiment, sensors 222a , 222b can generally detect atmospheric conditions that can cause flame out conditions in engines 218. Flame out conditions may exist when atmospheric moisture, relative or absolute humidity, temperature, ice, etc., meet, exceed, or otherwise move beyond a certain threshold. Sensors 222a , 222b can also detect clouds, rain, and other atmospheric conditions that may cause flame out conditions.

In an exemplary embodiment, flameout conditions logic controller 224 can work in conjunction with, or independently from vehicle management computer 220. In certain embodiments, vehicle management computer 220 can contain or be integrated with flameout conditions logic controller 224. In certain embodiments, flameout conditions logic controller 224 is a controller integrated with igniter controller 226, engine 218 control etc.

In an exemplary embodiment, flameout conditions logic controller 224 monitors sensors 222a , 222b for flameout conditions. In certain embodiments, readings from sensors 222a , 222b are compared to predefined or preset thresholds for sensor readings, to indicate environmental conditions where flame outs are more likely to occur. In certain embodiments, a user, technician, etc. can set a threshold, such as a moisture threshold or temperature threshold to compare against sensor 222a , 222b inputs. In an exemplary embodiment, flameout conditions logic controller 224 can accordingly engage a conditional response if a sensor 222a , 222b reading meets or exceeds a predefined threshold. Similarly, flameout conditions logic controller 224 can disengage a conditional response if a threshold is no longer met.

In certain embodiments, flameout conditions logic controller 224 can automatically engage and disengage a conditional response in response to certain detected conditions. In other embodiments, flameout conditions logic controller 224 can additionally signal to a pilot, operator, etc., that a conditional response is being utilized. In certain embodiments, the flameout conditions logic controller 224 can signal for an operator or pilot to engage or disengage a conditional response.

In an exemplary embodiment, the conditional response can include, but is not limited to engaging or disengaging an igniter 228 of an engine 218. In certain embodiments, igniters 228 are controlled by an igniter controller 226, which can be part of an overall engine 218 controller. While in other embodiments, igniters 228 are directly controlled by flameout conditions logic controller 224. Igniters are typically found on aircraft engines 228 and are used to ignite engines 218 to start or restart engines 218. Igniters can be ignited by vehicle management computer 220, flameout conditions logic controller 224, engine 218 controller, or igniter controller 226.

Advantageously, flameout conditions logic controller 224 can engage igniter 228 when flame out conditional thresholds are exceeded. In an exemplary embodiment, engaging igniters 228 can proactively prevent a flame out condition from occurring. In certain embodiments, when flame out conditions thresholds are not reached, igniters 228 can be disengaged.

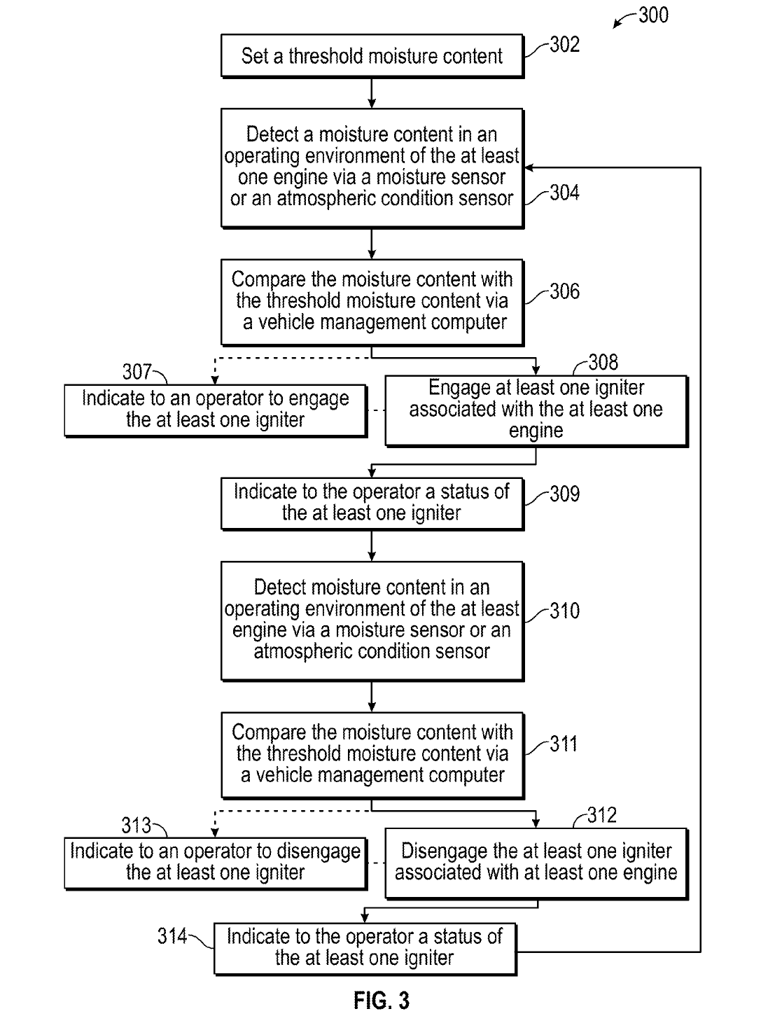

FIG. 3 illustrates a method 300 for conditionally engaging an igniter to prevent flame out conditions. In operation 302, in an exemplary embodiment, an operator, user, technician, etc., sets a threshold moisture content or other environmental parameter threshold for the conditional igniter logic. In an exemplary embodiment, previous experience, lookup tables, etc., are used to set a proper threshold. In certain embodiments, the threshold set can provide an additional safety factor or margin to prevent flameout conditions. In an exemplary embodiment, the threshold is adaptively set based on changing environmental parameters.

In operation 304, in an exemplary embodiment, moisture content is detected via a moisture or atmospheric condition sensor. In an exemplary embodiment, the sensors are disposed relative to the engines to provide representative readings of the conditions experienced by the engines. In certain embodiments, moisture content is periodically or continuously detected via moisture or atmospheric condition sensors to allow moisture content comparisons to be performed.

In operation 306, in an exemplary embodiment, sensor readings are compared to the previously determined threshold, via a flameout conditions logic controller. In certain embodiments, the flameout conditions logic controller is integrated in a vehicle management computer.

In operation 308, in an exemplary embodiment, at least one igniter that is associated with at least one engine is engaged if a sensor reading exceeds a predetermined threshold. Advantageously, engaging at least one igniter can prevent flame out conditions. In an exemplary embodiment, an igniter is engaged if a moisture content exceeds a threshold moisture content.

In operation 307, in an alternative embodiment, the flameout condition logic controller can indicate to the pilot or operator to engage at least one igniter in response to a threatened flame out condition or to otherwise prevent a flameout condition.

In operation 309, in an exemplary embodiment, the status of the igniters are indicated to the user, pilot, operator, etc.

In operation 310, in an exemplary embodiment, moisture content is detected via a moisture or atmospheric condition sensor. In an exemplary embodiment, the sensors are disposed relative to the engines to provide representative readings of the conditions experienced by the engines. In certain embodiments, moisture content is periodically or continuously detected via moisture or atmospheric condition sensors to allow moisture content comparisons to be performed.

In operation 311, in an exemplary embodiment, after the igniters are engaged, sensor readings are compared to the previously determined threshold, via a flameout conditions logic controller. In certain embodiments, the flameout conditions logic monitor will continue to monitor sensor readings to determine if igniters need to remain engaged in response to threatened flameout conditions or to otherwise prevent a flameout condition.

In operation 312, in an exemplary embodiment, the igniters are disengaged after a conditional threshold is no longer met and flameout conditions are no longer present. In an exemplary embodiment, flameout conditions logic controller can still compare sensor readings against a threshold to appropriately engage and disengage the igniters. In certain embodiments, the igniters can be disengaged automatically.

In operation 313, in an alternative embodiment, the flameout condition logic controller can indicate to the pilot or operator to disengage at least one igniter after a conditional threshold is no longer met and flameout conditions are no longer present.

In operation 314, in an exemplary embodiment, the status of the igniters are indicated to the user, pilot, operator, etc. In certain embodiments, the status of the igniters is periodically or continuously indicated.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A method for preventing a flame out condition in at least one engine, comprising:
detecting a moisture content exceeding a threshold moisture content in an operating environment of the at least one engine; and
engaging at least one igniter associated with the at least one engine in response to the moisture content.

2. The method of claim 1, further comprising disengaging the at least one igniter associated with the at least one engine in response to the moisture content below the threshold moisture content.

3. The method of claim 1, wherein the at least one engine is associated with an optionally piloted vehicle or an unmanned air vehicle.

4. The method of claim 1, further comprising detecting the moisture content via a moisture sensor or an atmospheric condition sensor.

5. The method of claim 1, further comprising comparing the moisture content with the threshold moisture content via a vehicle management computer.

6. The method of claim 1, further comprising setting the threshold moisture content.

7. The method of claim 1, wherein the threshold moisture content is a relative or absolute humidity percentage.

8. The method of claim 1, further comprising indicating to an operator to engage the at least one igniter in response to the moisture content.

9. The method of claim 1, further comprising indicating to the operator a status of the at least one igniter.

10. The method of claim 1, wherein the moisture content includes an ice content.

11. A system for preventing a flame out condition in at least one engine, comprising:
at least one sensor to detect a moisture content exceeding a threshold moisture content in an operating environment of the at least one engine; and
a controller to engage at least one igniter associated with the at least one engine in response to the moisture content.

12. The system of any of the preceding claim 11, wherein the controller disengages the at least one ignitor associated with the at least one engine in response to the moisture content below the threshold moisture content.

13. The system of claim 11, wherein the controller is integrated with a vehicle management computer.

14. The system of claim 11, wherein the controller sets the threshold moisture content.

15. The system of claim 11, wherein the controller indicates to an operator a status of the at least one igniter.
